(19) United States
(12) Patent Application Publication
(10) Pub. No.: US 2005/0139155 A1
(43) Pub. Date: Jun. 30, 2005

(54) Apparatus and method for coloring landscape material

(75) Inventors: John W. Spencer, Columbus, OH (US); Ralph T. Spencer, Jacksonville, FL (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(73) Assignee: MULCH MANUFACTURING, INC.

(21) Appl. No.: 11/025,701

(22) Filed: Dec. 29, 2004

Related U.S. Application Data
(60) Provisional application No. 60/533,601, filed on Dec. 30, 2003.

(51) Int. Cl. B05C 1/06; B05C 1/08; B05C 5/00

(52) U.S. Cl. 118/256; 118/258; 118/303

(57) ABSTRACT

An apparatus for coloring landscape material, including a frame and a drum rotatably mounted on the frame. The drum includes a longitudinal centerline and a wall that defines a chamber. A plurality of projections are formed on an inner surface of the wall in the chamber. A colorant delivery system includes a dispensing structure extending into the chamber and defines outlets for emitting colorant. The outlets are generally offset from the drum longitudinal centerline. The colorant delivery system delivers colorant to the chamber, and the landscape material is tumbled in the chamber by the projections when the drum rotates. A method for coloring landscape material is also provided.

### CROSS-REFERENCE TO RELATED APPLICATION

This application claims the benefit of U.S. Provisional Application Ser. No. 60/533,601, filed on Dec. 30, 2003.

### BACKGROUND OF THE INVENTION

1. Field of the Invention

The invention relates to the art of coloring systems for landscape material. More particularly, the invention relates to an apparatus and a method for coloring fibrous landscape material, such as mulch.

2. Background Art

In the landscape industry, natural fibrous material, such as mulch, is often placed around buildings, bushes, trees, stones and other items. The mulch is typically made by grinding wood down to relatively small fibers. The wood is sometimes obtained from newly-cut trees, but scrap wood, such as old shipping pallets, is often recycled and used as well. The natural color of the ground wood may not be desirable to certain consumers for use as landscaping mulch, or the color may not be uniform, particularly when scrap or recycled wood is ground to create the mulch.

To increase demand, the mulch is frequently artificially colored, which results in a much more visually pleasing and thus desirable product. For example, artificial coloring allows the mulch to be more uniform in appearance. In addition, artificial coloring allows different colors of mulch to be produced, such as various shades of brown, red and black, which often appeal to the preferences of certain users. As a result, the ability to artificially color mulch has become an important issue to many manufacturers of mulch products. Adding to this importance is the ability to color mulch with a colorant or other chemicals that are not considered to be toxic according to government standards.

To accomplish artificial non-toxic coloring of mulch in the prior art, machinery including a non-moving, or static, chamber has been used. Uncolored mulch is placed in the chamber and colorant, also known in the art as dye, in the form of a powder or liquid is delivered to the chamber. Paddles in the chamber rotate to mix the mulch with the colorant and are sometimes also used to convey the mulch out of the chamber once it has been colored. Other machines of the prior art utilize an auger in place of the paddles, whereby the auger mixes the mulch with the colorant and conveys the mulch out of the chamber.

In these paddle and auger machines, the mixing of the mulch and the colorant is considerably less than optimal, since the movement of the mulch by paddles or by an auger is limited. This limited movement of mulch reduces the amount and thoroughness of the contact between the mulch and the colorant, creating a product with reduced color and less uniformity of color. In addition, the machines of the prior art consume a large amount of colorant, in part to compensate for poor mixing, as well as a large amount of water, which is used to dilute concentrated colorant and disperse the colorant, as known in the art. A significant amount of energy is also required by such machines to adequately mix the colorant with the mulch and convey the product.

Furthermore, the nature of attempting to move mulch through a chamber with paddles or an auger necessarily creates points at which the mulch will jam in the between the paddle or auger and the wall of the chamber, potentially damaging the machine and disrupting the production process. Along these same lines, the principle underlying the design of paddle and auger type prior art machines also limits throughput capacity, since attempting to push and lift a significant amount of material with a series of paddles or flights on an auger limits the amount of material that is actually moved.

Attempts to overcome the disadvantages of paddle and auger machines led to the development of an early rotating drum machine, in which the mulch was conveyed and mixed with colorant by rotation of the drum or chamber, rather than by the motion of paddles or an auger. However, the rotating drum machine of the prior art is extremely long, on the order of about 45 feet in length for the rotating drum section alone. In this machine, the first one-third of the drum length includes a perforated wall to allow the screening of fine particles. The second one-third of drum length is used for colorant application, which is provided through a tube centered along the central longitudinal axis of the drum, and the final third of length is devoted to mixing the mulch and the colorant.

Such a long machine is not very efficient for the coloring process, as it requires a large production area and relatively high maintenance costs. The position of the colorant delivery system, that is, along the centerline of the drum in the second longitudinal section of the drum, is also somewhat inefficient. In addition, the internal construction of the prior art rotating drum, while providing increased mixing ability over paddle and auger machines, is still less than optimal. Moreover, the prior art drum rotates only at a fixed speed, limiting control over the coloring process. Contributing to the disadvantages of the early rotating drum machine is a material feed system that is often less than steady, leading to potential problems with uniformity of color and smooth processing.

As a result, a need exists in the art for an apparatus and a method that overcomes the problems of the prior art by coloring fibrous materials more efficiently and effectively, resulting in a higher throughput rate with less consumption of power, fewer process problems and improved product quality. The present invention provides such an apparatus and a method, which allows landscape material to be colored or dyed more efficiently and more effectively than with apparatus and processes of the prior art.

### BRIEF SUMMARY OF THE INVENTION

An objective of the present invention is to provide an apparatus and method for coloring landscape material with a high throughput rate and reduced process problems.

Another objective of the present invention is to provide an apparatus and method for coloring landscape material with efficient consumption of energy and of raw materials, such as colorant and water.

Yet another objective of the present invention is to provide an apparatus and method for coloring landscape material that provides high-quality coloring of the material.

These objectives and others are obtained by the apparatus for coloring landscape material of the present invention, the general nature of which may be stated as including a frame and a drum rotatably mounted on the frame. The drum includes a longitudinal centerline and a wall that defines a chamber. A plurality of projections are formed on an inner surface of the wall in the chamber. A colorant delivery system includes a dispensing structure extending into the chamber and defines outlets for emitting colorant. The outlets are generally offset from the drum longitudinal centerline. The colorant delivery system delivers colorant to the chamber, and the landscape material is tumbled in the chamber by the projections when the drum rotates.

The general nature of the apparatus for coloring landscape material of the present invention may also be stated as including a feed hopper that includes a feed end, a discharge end, a conveyor belt between the feed end and the discharge end, and a metering structure disposed above the conveyor belt. A rotatable drum is disposed proximate the discharge end of the feed hopper and defines an inner chamber. A plurality of projections is formed in the chamber of the drum. A colorant delivery system is also included. The feed hopper conveys a substantially uniform flow of uncolored landscape material to the chamber and the colorant delivery system delivers colorant to the chamber, and the landscape material is tumbled in the chamber by the projections when the drum rotates.

The general nature of the apparatus for coloring landscape material of the present invention may further be stated as including a frame and a drum rotatably mounted on the frame. The drum includes a wall defining a chamber having a feed end and a discharge end. A plurality of projections are formed on an inner surface of the wall in the chamber. A colorant delivery system, including a dispensing structure extending into the feed end of the chamber, delivers colorant to the chamber. The landscape material is tumbled in the chamber by the projections when the drum rotates.

These objectives and others are also obtained by the method for coloring landscape material of the present invention, the general nature of which may be stated as including the steps of feeding uncolored landscape material into a drum and rotating the drum. The landscape material is tumbled in the drum with a plurality of projections formed in the drum. A colorant delivery system, including a dispensing structure proximate a feed end of the drum is provided. A colorant solution is sprayed into the drum with the dispensing structure and is applied to the landscape material.

### BRIEF DESCRIPTION OF THE SEVERAL VIEWS OF THE DRAWINGS

The preferred embodiments of the invention, illustrative of the best modes in which applicant has contemplated applying the principles of the invention, are set forth in the following description and are shown in the drawings, and are particularly and distinctly pointed out and set forth in the appended claims.

FIG. 1 is a fragmentary side perspective view of a first embodiment of the coloring system of the present invention;

FIG. 2 is a side elevational view of the coloring system shown in FIG. 1;

FIG. 3 is an enlarged fragmentary perspective view of a portion of the coloring system shown in FIG. 1, with hidden areas represented by dotted lines;

FIG. 4 is an enlarged fragmentary end view of a portion of the coloring system shown in FIG. 1;

FIG. 5 is a sectional view of a portion of the coloring system shown in FIG. 4, taken along the line marked “5-5” in FIG. 4;

FIG. 6 is a schematic representation of a control system of the coloring system of the present invention; and

FIG. 7 is a side elevational view of a second embodiment of the coloring system of the present invention, with hidden areas represented by dotted lines.

Similar numerals refer to similar parts throughout the drawings.

### DETAILED DESCRIPTION OF THE INVENTION

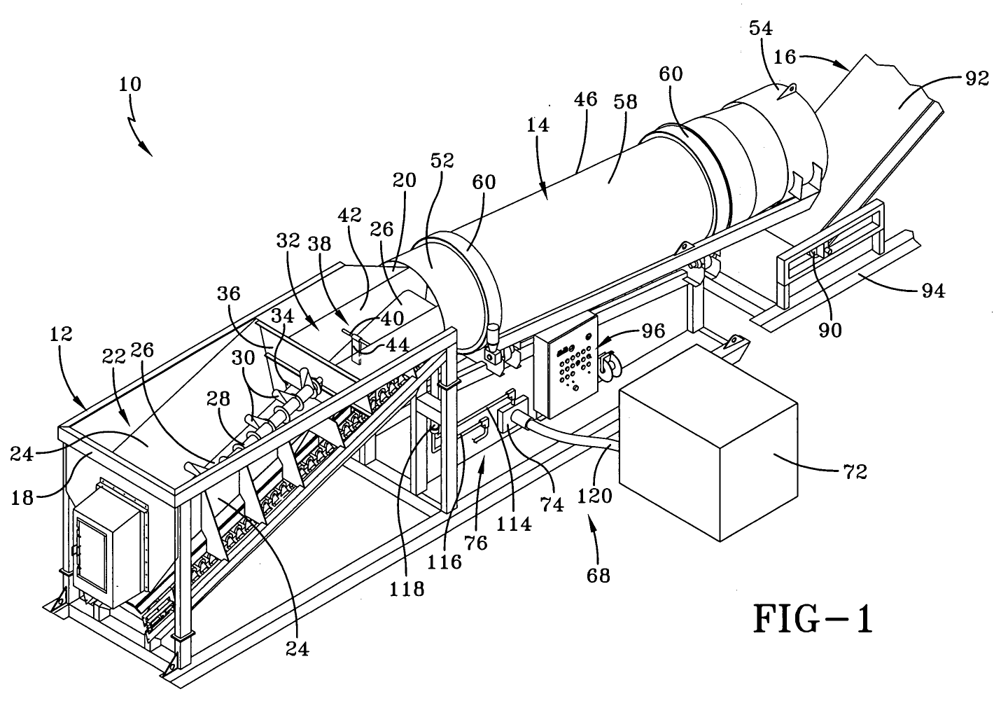

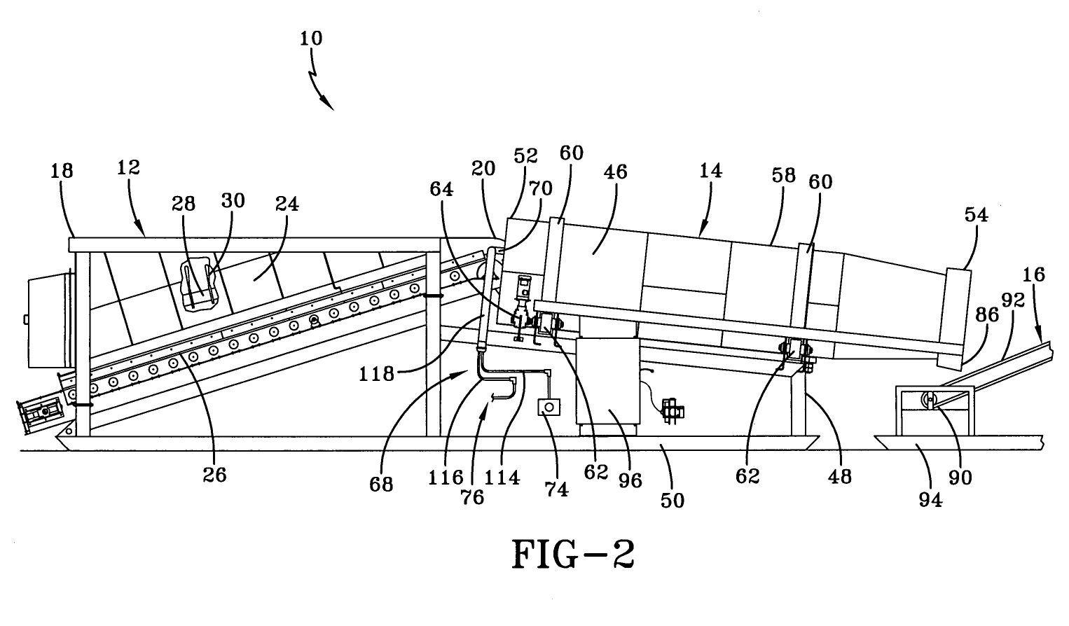

Turning now to the drawings, wherein the illustrations are provided to show preferred embodiments of the invention and not to limit the same, a first embodiment of the coloring system of the present invention is indicated generally at 10 and is shown in FIGS. 1 and 2. Coloring system 10 includes a feed hopper 12, a trommel 14 and a conveyor 16. Uncolored mulch is placed in feed hopper 12, conveyed to trommel 14 for coloring, as will be described in detail below, and discharged onto conveyor 16 for removal.

Feed hopper 12 preferably is a constant-flow hopper that delivers a relatively steady flow of mulch to trommel 14. Feed hopper 12 includes a feed end 18 and a discharge end 20. Uncolored mulch (not shown) is placed in a bin 22, which is formed in hopper 12 proximate feed end 18. The mulch may be dumped into bin 22, or alternatively, mulch may be continually conveyed into the bin through a delivery system known to those skilled in the art. To accommodate batches of mulch, bin 22 preferably includes a volumetric capacity of about 15 cubic yards. Sides 24 of bin 22 slope inwardly from the top of the bin as they extend downwardly, thus feeding mulch to a conveyor belt 26 at the bottom of the bin and to an agitator 28, which is longitudinally disposed above the conveyor belt.

Conveyor belt 26 conveys mulch toward discharge end 20 of hopper 12 and preferably is a two-ply, 36 inch-wide belt with projections, such as chevrons, formed on its surface to assist in material conveyance. As conveyor 26 conveys mulch toward discharge end 20, agitator 28 rotates to agitate the mulch and thereby reduce the tendency of the mulch to bridge or clump. Agitator 28 is preferably driven by a 5 horsepower (hp) motor and includes flights 30 as known in the art, which contact the mulch to provide increased agitation. Preferably, conveyor belt 26 and agitator 28 are angled upwardly from feed end 18 to discharge end 20 of hopper 12.

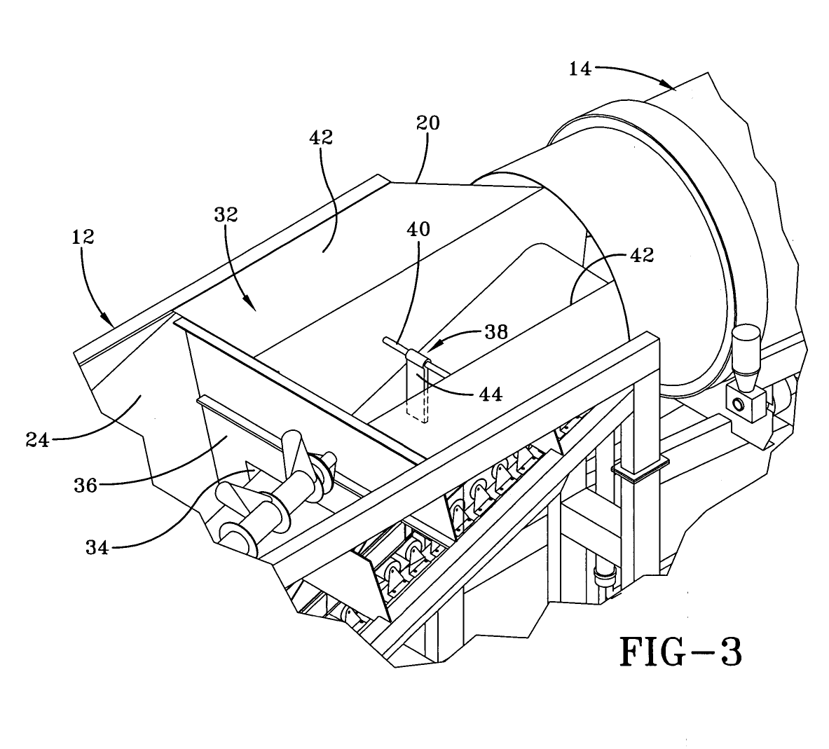

Conveyor belt 26 conveys mulch into a delivery chute 32 formed in feed hopper 12 proximate discharge end 20. With additional reference to FIG. 3, to create a uniform flow of mulch into delivery chute 32, feed hopper 12 includes a metering structure such as an opening 34 that is formed in an end plate 36 of bin 22 above conveyor belt 26 and below the centerline of agitator 28. The area of opening 34 is of an appropriate size to allow an optimal volume of mulch to pass from bin 22 into delivery chute 32 and into trommel 14. It is to be noted that conveyor belt 26 extends along the bottom of feed hopper 12 from feed end 18 to discharge end 20, thereby providing uniformity of movement of mulch from bin 22 to and through delivery chute 32. In discharge chute 32, conveyor belt 26 carries the metered mulch to discharge end 20, where the mulch drops off the end of the conveyor belt and into trommel 14.

Feed hopper 12 includes an automatic cut-off sensor 38 disposed over belt 26 in discharge chute 32. Cut-off sensor 38 senses the presence of mulch on conveyor belt 26. When there is no mulch on conveyor belt 26 in discharge chute 32, sensor 38 activates a controller (not shown) that shuts down the flow of colorant and water into trommel 14, thereby conserving resources in the coloring process. Once a flow of material is detected by cut-off sensor 38, the controller reactivates the flow of colorant and water into trommel 14.

To sense mulch on belt 26, cut-off sensor 38 includes a bar 40 that is mounted to opposing sides 42 of chute 32 over the belt. A paddle 44 is pivotally mounted on and depends from bar 40, extending downwardly toward belt 26. Paddle 44 is positioned to contact mulch on belt 26 that passes through opening 34 in bin 22, yet to allow a gap (not shown) between the end of the paddle and the belt when there is no mulch on the belt. Thus, when there is no mulch on belt 26, paddle 44 hangs in an approximately vertical position. When there is mulch on belt 26, paddle 44 contacts the mulch and the movement of the mulch on the belt toward discharge end 20 causes the paddle to pivot to an angled position. The controller of cut-off sensor 38 detects this angled position of paddle 44 and engages the flow of water and colorant into trommel 14, and disengages the flow of water and colorant when the paddle returns to an approximately vertical position.

Feed hopper 12 is preferably integrated with trommel 14. However, it is not necessary for hopper 12 to be integrated with trommel 14. Alternatively, trommel 14 may be fed by a constant flow feed from a different source as known in the art, such as an input conveying system (not shown).

Referring now to FIGS. 1, 2 and 4, trommel 14 includes a cylindrical drum 46 rotatably mounted on a support frame 48 that is in turn mounted on a base 50. A feed end 52 of trommel 14 preferably is located proximate discharge end 20 of feed hopper 12 and a discharge end 54 of the trommel is distal to the feed end. Drum 46 forms a trommel chamber 56 that extends from feed end 52 to discharge end 54. Trommel 14 is angled downwardly from feed end 52 to discharge end 54 to allow the force of gravity to assist in material flow, thereby reducing the energy required by the trommel to convey mulch.

Drum 46 includes a solid wall 58 on which a pair of spaced-apart rings 60 are mounted to facilitate rotation of the drum on support frame 48. One ring of pair 60 is located near feed end 52, while the other is located near discharge end 54. Support frame 48 includes a drive system 62 that engages rings 60, causing drum 46 to rotate while the support frame remains static. The speed of rotation of drum 46 is variable, preferably ranging from about 5 revolutions per minute (rpm) to about 15 rpm. Drive system 62 for drum 46 includes a motor 64 of suitable power, such as 15 hp, which results in considerable energy savings over larger motors that are required by prior art paddle and auger machines.

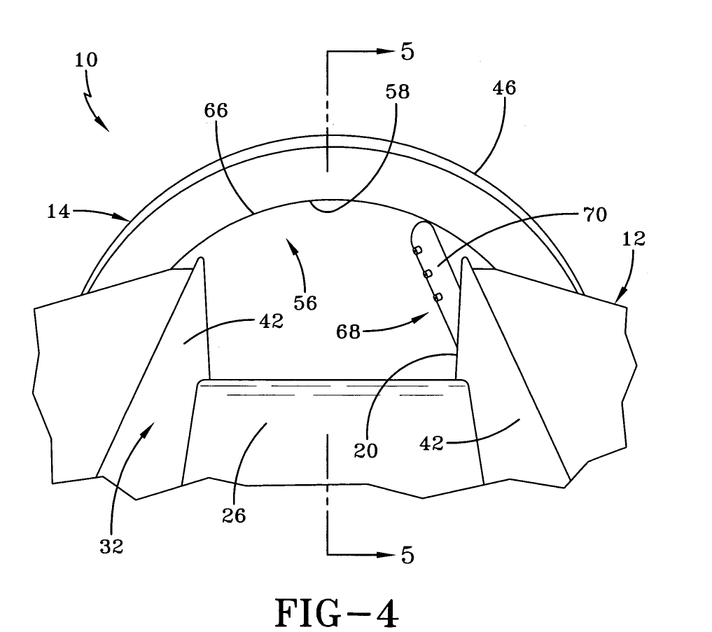

As shown in FIG. 4, the uncolored mulch drops from discharge end 20 of feed hopper 12 into a mouth 66 of trommel chamber 56 of rotating drum 46. To color the mulch, colorant is delivered to trommel chamber 56 via a colorant delivery system 68. Colorant delivery system 68 includes a spray bar 70 that extends into trommel chamber 56 of drum 46, but does not rotate with the drum. Colorant delivery system 68 also includes a container 72 of concentrated colorant (FIGS. 1 and 2), which is preferably located proximate trommel 14, but can be located some distance away. The concentrated colorant is in a liquid form and a peristaltic pump 74, preferably using a 0.5 hp motor, fluidly conveys the concentrated colorant from container 72 to a delivery sub-system 76 via a hose 120, where the concentrated colorant is mixed with incoming water in a predetermined ratio. That is, the colorant proceeds through a colorant line 114 and water proceeds through a water line 116. Both colorant line 114 and water line 116 are valved to control fluid flow. Colorant line 114 and water line 116 fluidly connect to vertical tube 118, which in turn fluidly connects to spray bar 70 (FIG. 4). The mixing ratio is controlled by the flow rate of the colorant and the flow rate of the water, which is measured by a control system, to be discussed below.

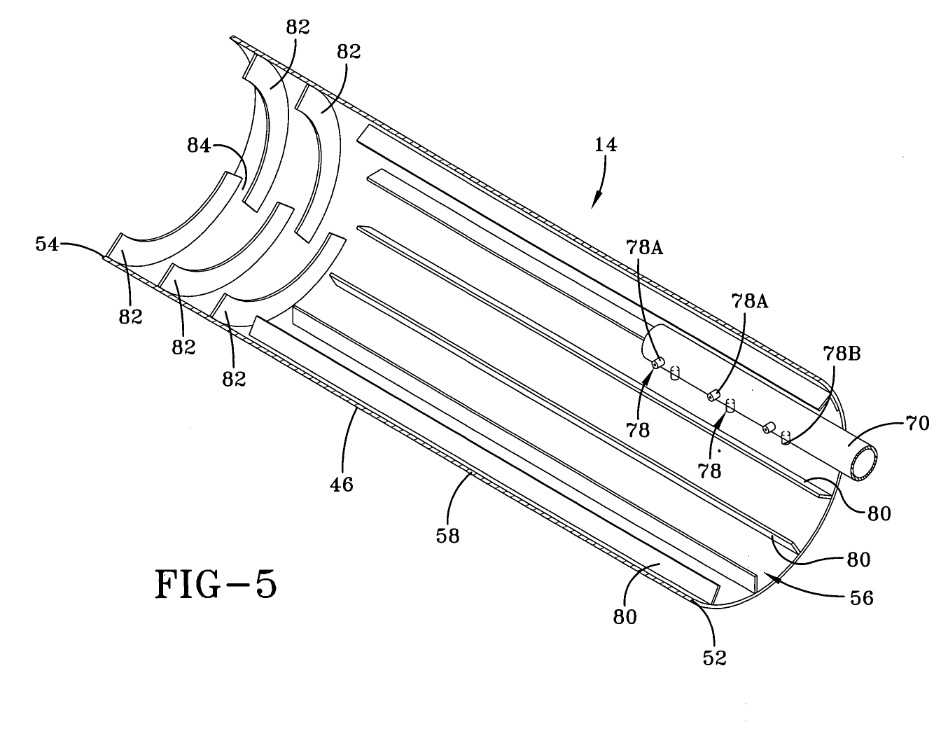

As shown in FIGS. 4 and 5, spray bar 70 is statically mounted offset from the longitudinal centerline of drum 46, near drum wall 58, and extends into trommel chamber 56 from feed end 52. Spray bar 70 extends into trommel chamber 56 of drum 46 for a relatively short length, such as from about 3 to 6 feet. To accomplish optimal delivery of the colorant solution, spray bar 70 preferably is a tube that is about 3.5 inches in diameter.

Mounted on spray bar 70 are spray nozzles 78 that spray the colorant solution onto the mulch. Preferably, about 6 to 10 nozzles 78 are used and are spaced apart longitudinally along the length of spray bar 70. Nozzles 78 are also spaced apart radially about a portion of the circumference of spray bar 70, including a generally horizontal interior-facing position 78A and a generally vertical downward-facing position 78B. Of course, other positions for nozzles 78 about the circumference of spray bar 70 may be used without affecting the overall concept of the invention. Nozzles 78 preferably spray the colorant solution as a mist, rather than a sharp stream, in a radial pattern. This spray technique allows the colorant solution to be directly deposited on mulch that is passing through trommel chamber 56 of drum 46, which provides efficient and effective application of the colorant on the mulch.

In this manner, as drum 46 rotates and mulch is delivered into mouth 66, spray bar 70 sprays the colorant solution onto the mulch flowing through trommel chamber 56 of the drum. The off-center location of spray bar 70 in trommel chamber 56 allows the colorant solution to be directed via nozzles 78 toward the center of the trommel chamber, thereby causing the colorant to actually contact airborne mulch in the center of drum 46. The radially offset location of spray bar 70, as well as the longitudinal position of the spray bar in mouth 66 of drum 46, allows uninterrupted delivery of colorant onto the airborne mulch, to be described in greater detail below, which is more efficient than prior art systems and provides more effective coverage of the mulch.

As shown in FIG. 5, to promote mixing of the mulch and the colorant solution, the inner surface of wall 58 of drum 46 includes a plurality of parallel, circumferentially spaced-apart flights 80 that extend longitudinally from feed end 52 to a location near discharge end 54 of trommel 14. As mulch is delivered into mouth 66 (FIG. 4), the material falls into contact with the inner surface of wall 58, whereupon longitudinal flights 80 catch the mulch and cause it to rotate as drum 46 rotates. When the mulch reaches the apex of rotation along drum 46, the mulch drops due to the force of gravity and falls through the misting of the colorant solution provided by spray bar 70 and nozzles 78. This tumbling action continues as drum 46 rotates.

The downward angle of drum 46 from feed end 52 to discharge end 54 causes the mulch to proceed from the feed end to the discharge end as longitudinal flights 80 tumble it. The length of longitudinal flights 80, coupled with the length of spray bar 70 and the presence of multiple nozzles 78 along the spray bar, allows the mulch to be exposed to the misting of the colorant solution in an airborne manner repeatedly, thereby increasing the coverage of the colorant on the mulch. As the mulch proceeds toward discharge end 54 past the end of spray bar 70, it continues to be lifted and tumbled by longitudinal flights 80, thus mixing the mulch and distributing colorant to mulch that may not have been directly exposed to the colorant solution by nozzles 78.

Near discharge end 54 of drum 46, longitudinal flights 80 terminate and helical flights 82 commence. Helical flights 82 extend to discharge end 54 and include a plurality of individual flights. Helical flights 82 are mounted on the inner surface of wall 58, and are longitudinally spaced apart in a staggered manner about the inner circumference of drum 46. Each flight 82 extends about the inner circumference of drum 46 for distance that is about one-quarter of the circumference. Helical flights 82 convey the mulch out of trommel 14 once the mulch nears discharge end 54. The ability of helical flights 82 to convey mulch is increased by a gap 84 formed between individual flights, allowing the material to be swept up and moved more effectively by each flight.

Returning now to FIG. 2, a static discharge chute 86 is located at discharge end 54 of rotating drum 46, directing the colored mulch out of the drum onto conveyor 16. Conveyor 16 may be a stacking conveyor or a linear conveyor. For either type, a feed end 90 of conveyor 16 receives mulch and a conveyor belt 92 transports the mulch away from trommel 14. Conveyor belt 92 is preferably about 30 inches wide and about 50 feet long. A support stand 94, preferably of steel, supports conveyor belt 92 and a motor (not shown) drives the conveyor belt, as known in the art. Preferably, the motor that drives conveyor belt 92 is a 5 hp motor. When conveyor 16 is a radial conveyor, pneumatic tires on pivoting arms (not shown) are also included, as known to those skilled in the art.

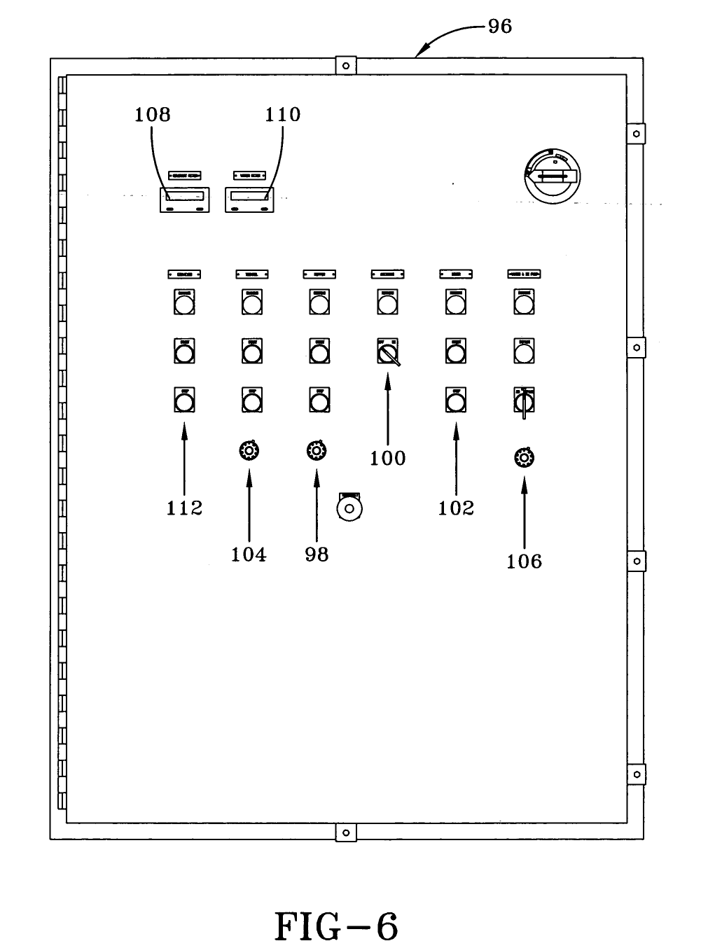

To control coloring system 10, a control system 96 is utilized, as shown in FIGS. 1, 2 and 6. Controls for feed hopper 12 preferably include speed controls 98 and 100 for agitator 28, and a drive control 102 for the motor that drives hopper conveyor belt 26. A drive control 104 controls the speed of rotation of drum 46 of trommel 14. Peristaltic pump 74 of colorant delivery system 68 is controlled by a pump drive control 106, while the rate of flow of concentrated colorant is measured by a flow meter 108. The rate of flow of water that is mixed with the concentrated colorant is also measured by a flow meter 110, thus enabling monitoring and control of the composition of the colorant solution. The motor that drives belt 92 of conveyor 16 is controlled by a belt drive control 112. In this manner, control system 96 allows each piece of equipment in coloring system 10 to be monitored and controlled from a central location.

Coloring system 10 includes many advantages over systems of the prior art. For example, the action of rotating drum 46 and the position of spray bar 70 cause colorant to be delivered evenly to the mulch and to be dispersed throughout the mulch more effectively than in prior art systems. In addition, rotating drum 46, longitudinal flights 80 and helical flights 82, as well as the off-center position of spray bar 70, keep the mulch moving and tumbling for better mixing with the colorant, as the mulch is airborne for a significant time, which promotes better mixing.

The tumbling action also results in a more free-flow of mulch through drum 46, which increases the throughput rate of coloring system 10. The throughput rate of coloring system 10 is in a range of from about 50 yards of mulch per hour to about 350 yards of mulch per hour, as compared to 100 yards of mulch per hour in typical prior art processes. Coloring system 10 uses less power as a result of the free-flow characteristic, with about 25 hp being used, versus 40-70 hp for prior art systems. This reduction in required power results in substantial energy savings for coloring system 10. The free-flow of mulch created by rotating drum 46 also results in less jamming of mulch in the drum and less damage caused by such jamming.

Furthermore, the use of rotating drum 46 and colorant delivery system 68 reduces the amount of water required, as well as the amount of concentrated colorant that is required, leading to raw material cost savings. The reduced water consumption also leads to a lighter and brighter finished product, which is more desirable to consumers.

The design of trommel 14 and feed hopper 12 allow the trommel to have a reduced length over the prior art drum-style coloring system, with a trommel length of about 20 feet, rather than about 45 feet, increasing the amount of available production space and providing a more efficient process. In addition, longitudinal flights 80 and helical flights 82 provide significant improvements for trommel 14 over the prior art rotating-drum system. For example, helical flights 82 are not used in the prior system, while any longitudinally-extending flights in the prior art are significantly smaller and fewer in number than longitudinal flights 80 of trommel 14, leading to increased mixing and conveying by coloring system 10 of the present invention.

It is to be noted that trommel 14 is preferably made from steel. For example, structural steel tubing and plate may be used to fabricate base 50, support frame 48 and drum 46, while sheet metal may be used to fabricate discharge chute 86. Moreover, structural elements of feed hopper 12 and conveyor 16 are also preferably made from steel.

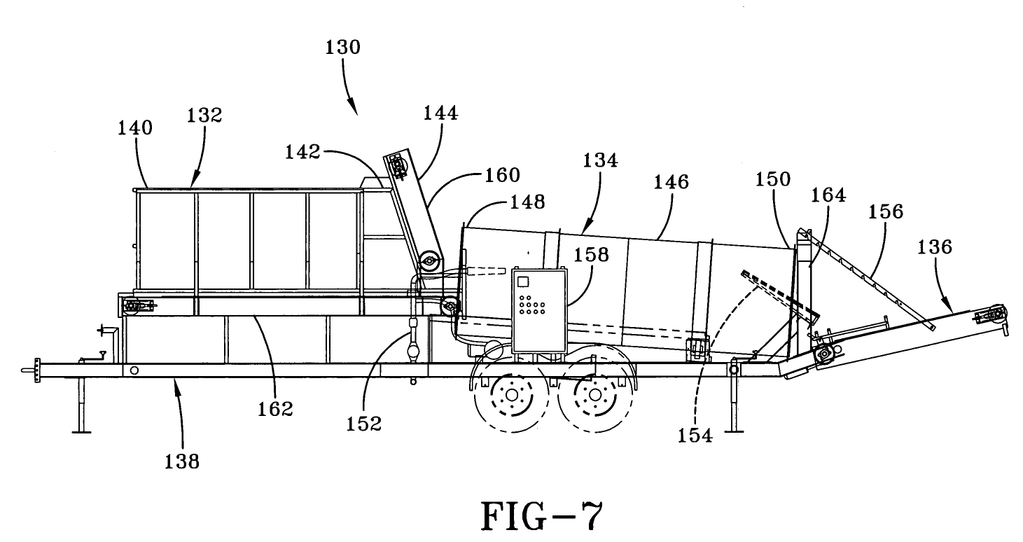

Turning now to FIG. 7, a second embodiment of the coloring system of the present invention is indicated generally at 130. Second embodiment coloring system 130 includes a feed hopper 132, a trommel 134 and a discharge conveyor 136. Second embodiment coloring system 130 includes features and components similar to first embodiment coloring system 10 (FIGS. 1-6), with additional aspects as described below.

One additional aspect is a reduced size of feed hopper 132, trommel 134 and discharge conveyor 136 as compared to feed hopper 12, trommel 14 and conveyor 16 of first embodiment coloring system 10. Second embodiment feed hopper 132, trommel 134 and discharge conveyor 136 are all of an appropriate size to fit onto a trailer 138, which is in turn towed by a vehicle (not shown) to a suitable location for coloring mulch. Thus, second embodiment coloring system 130 is essentially a portable version of first embodiment system 10. An exemplary total length for second embodiment coloring system 130 is about 35 feet.

Feed hopper 132 includes a feed end 140 and a discharge end 142. Uncolored mulch (not shown) is placed in feed hopper 132, which conveys the mulch to trommel 134 in a metered fashion, as described above for first embodiment coloring system 10. A second additional aspect of second embodiment coloring system 130 is hopper discharge conveyor 144, which is a metering structure that is mounted to discharge end 142 of hopper 132 in a substantially vertical orientation. Hopper discharge conveyor 144 includes a belt 160 that moves upwardly on the feed side and downwardly on the discharge side. The bottom of hopper discharge conveyor 144 is slightly above the discharge end of a conveyor belt 162 at the bottom of feed hopper 132, which is similar to conveyor belt 26 in hopper 12 of system first embodiment 10. The location of hopper discharge conveyor 144 and the travel direction of its belt 160 enables the hopper discharge conveyor 144 to rake excess mulch off of hopper conveyor belt 162, and allows the excess mulch to fall back into feed hopper 132. This creates a more efficient metering of the mulch, in turn leading to more uniform feeding of the mulch into trommel 134.

Trommel 134 includes a cylindrical drum 146 rotatably mounted on trailer 138. A feed end 148 of trommel 134 preferably is located proximate discharge end 142 of feed hopper 132 and a discharge end 150 of the trommel is distal to the feed end. Thus, uncolored mulch drops from discharge end 142 of feed hopper 132 into feed end 148 of trommel 134. To color the mulch, colorant is delivered to trommel drum 146 via a colorant delivery system 152. The construction of colorant delivery system 152 and trommel drum 146 are similar to that as described above for first embodiment coloring system 10, as is the process for coloring the mulch.

A discharge chute 154 is located at discharge end 150 of trommel drum 146, directing the colored mulch out of the drum onto discharge conveyor 136. A third additional aspect of second embodiment coloring system 130 is the structure and position of discharge chute 154, which extends into drum 146 in an angular manner. That is, discharge chute 154 is angled downwardly as it extends past discharge end 150 of drum 146. With discharge chute in trommel drum 146 and angled downwardly toward discharge conveyor 136, the colored mulch is transferred more efficiently from the trommel drum onto the discharge conveyor.

A fourth additional aspect of second embodiment coloring system 130 is an attachment arm 156 for discharge conveyor 136. Discharge conveyor 136 is pivotally attached to trailer 138 for ease of transport. When second embodiment coloring system 130 is in use, discharge conveyor 136 is lowered to a desired angle and attachment arm 156 engages a frame beam 164 to secure the position of the conveyor. As with first embodiment coloring system 10, to control second embodiment coloring system 130, a central control system 158 is utilized.

With these features, second embodiment coloring system 130 is readily transportable, and can thus be taken to a mulch site. This eliminates the need to load the mulch into trucks and transport it to a central facility for coloring, thereby reducing the cost of coloring the mulch and increasing the convenience of the coloring process. It is to be noted that various features of second embodiment coloring system 130, such as hopper discharge conveyor 144 and discharge chute 154, may also be used with first embodiment coloring system 10.

The present invention also includes a method of coloring landscape material, such as mulch. The method comprises the coloring of mulch in accordance with the steps presented above. For example, referring to first embodiment coloring system 10 for convenience, mulch is delivered via a constant flow to a rotating drum 46. Longitudinal flights 80 in rotating drum 46 contact the mulch and cause it to tumble about trommel chamber 56 of the drum and a colorant solution is sprayed onto the mulch by an off-center spray bar 70. The mulch continues through drum 46 as longitudinal flights 80 continue to cause the mulch to tumble and mix with the colorant. Near discharge end 54 of drum 46, helical flights 82 in the rotating drum convey the colored mulch out of the drum.

The coloring system 10, 130 of the present invention thus allows landscape material, such as mulch, to be colored or dyed more efficiently and more effectively than apparatus and processes of the prior art. The invention allows a higher throughput rate to be accomplished with reduced energy consumption, as well as reduced consumption of concentrated colorant and water. The end product achieved by the present invention is a higher quality colored mulch, being lighter in weight and more uniform in color than mulch that is colored according to prior art systems.

It is also to be noted that the concentrated colorant and other materials used by colorant system 10, 130 of the invention are non-toxic, thereby yielding a colored mulch end product that is non-toxic according to government standards.

Accordingly, the coloring system of the present invention is simplified, provides an effective, safe, inexpensive, and efficient system which achieves all the enumerated objectives, provides for eliminating difficulties encountered with prior art coloring systems, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved coloring system is constructed, arranged and used, the characteristics of the construction and arrangement, and the advantageous, new and useful results obtained; the new and useful structures, devices, elements, arrangements, parts and combinations, are set forth in the appended claims.

1. An apparatus for coloring landscape material, comprising:
a frame;
a drum rotatably mounted on said frame, said drum including a longitudinal centerline and a wall defining a chamber;
a plurality of projections formed on an inner surface of said wall in said chamber; and
a colorant delivery system, said system including a dispensing structure extending into said chamber and defining outlets for emitting colorant, said outlets being generally offset from said drum longitudinal centerline, whereby colorant is delivered to said chamber, and said landscape material is tumbled in said chamber by said projections when said drum rotates.

2. The apparatus for coloring landscape material of claim 1, wherein a substantial amount of said outlets are proximate a feed end of said chamber.

3. The apparatus for coloring landscape material of claim 1, wherein said plurality of projections includes helical flights.

4. The apparatus for coloring landscape material of claim 1, wherein said drum includes a discharge chute extending into a discharge end of said chamber to direct landscape material out of said chamber.

5. The apparatus for coloring landscape material of claim 1, wherein said drum is mountable on a trailer.

6. The apparatus for coloring landscape material of claim 1, further comprising a feed hopper including a feed end, a discharge end, and a conveyor belt between said feed end and said discharge end, whereby said feed hopper delivers uncolored landscape material to said drum.

7. The apparatus for coloring landscape material of claim 6, wherein said feed hopper includes a second conveyor belt disposed in a substantially vertical position at said discharge end of said feed hopper to meter said landscape material.

8. The apparatus for coloring landscape material of claim 6, further comprising a discharge conveyor for moving landscape material away from said drum after said material has been colored.

9. The apparatus for coloring landscape material of claim 8, wherein said drum, feed hopper and discharge conveyor are mountable on a trailer.

10. An apparatus for coloring landscape material, comprising:
a feed hopper including a feed end, a discharge end, a conveyor belt between said feed end and said discharge end, and a metering structure disposed above said conveyor belt;
a rotatable drum disposed proximate said discharge end of said feed hopper defining an inner chamber;
a plurality of projections formed on said drum inside said chamber; and
a colorant delivery system, whereby said feed hopper conveys a substantially uniform flow of uncolored landscape material to said chamber and said colorant delivery system delivers colorant to said chamber, and said landscape material is tumbled in said chamber by said projections when said drum rotates.

11. The apparatus for coloring landscape material of claim 10, wherein said feed hopper and said drum are mountable on a frame.

12. The apparatus for coloring landscape material of claim 11, wherein said frame includes a trailer.

13. The apparatus for coloring landscape material of claim 10, wherein said feed hopper includes a cut-off sensor capable of terminating colorant flow into said drum when a select amount of uncolored landscape material is not present on said conveyor belt of said feed hopper.

14. The apparatus for coloring landscape material of claim 10, further comprising a discharge conveyor for moving landscape material away from said drum after said material has been colored.

15. An apparatus for coloring landscape material, comprising:
a frame;
a drum rotatably mounted on said frame, said drum including a wall defining a chamber having a feed end and a discharge end;
a plurality of projections formed on an inner surface of said wall in said chamber; and
a colorant delivery system, said system including a dispensing structure extending into said feed end of said chamber, whereby colorant is delivered to said chamber, and said landscape material is tumbled in said chamber by said projections when said drum rotates.

16. The apparatus for coloring landscape material of claim 15, wherein said drum is mountable on a trailer.

17. A method for coloring landscape material, comprising the steps of:
feeding uncolored landscape material into a drum;
rotating said drum;
tumbling said landscape material in said drum with a plurality of projections formed in said drum;
providing a colorant delivery system, including a dispensing structure proximate a feed end of said drum; and
spraying a colorant solution into said drum with said dispensing structure, whereby said colorant solution is applied to said landscape material.

18. The method for coloring landscape material of claim 17, wherein said dispensing structure is offset from a longitudinal centerline of said drum.

19. The method for coloring landscape material of claim 17, further comprising the step of flowing colored landscape material out of a discharge end of said drum.

20. The method for coloring landscape material of claim 17, wherein the step of feeding uncolored landscape material into a drum includes feeding a substantially uniform flow of said landscape material.
